(19) United States
(12) Patent Application Publication
(10) Pub. No.: US 2012/0284638 A1
(43) Pub. Date: Nov. 8, 2012

(54) SYSTEM AND METHOD FOR SOCIAL INTERACTION, SHARING AND COLLABORATION

(75) Inventors: Matthew Cutler, Needham, MA (US); David Greenstein, Boston, MA (US)

(73) Assignee: Kibits Corp., Cambridge, MA (US)

(21) Appl. No.: 13/465,572

(22) Filed: May 7, 2012

Related U.S. Application Data
(60) Provisional application No. 61/483,176, filed on May 6, 2011.

(51) Int. Cl. G06F 3/01

(52) U.S. Cl. 715/751

(57) ABSTRACT

A system and method for real-time, social networking, sharing and collaborating is disclosed. An application for the networking, sharing and collaborating is downloaded onto a mobile device, such as a smartphone, or onto a networked computer. Users log into the application and send invitations to other users to form groups for on-line sharing and collaboration. Persons may be invited to join a group via their e-mail addresses, other affinity address, or proximity to each other through a resident global positioning system. Once a group is formed, nearly instantaneous communications are maintained without e-mail or instant messaging systems. Participants may share files, notes, photos, videos, music, contacts and other items with each other and store shared items. Communications take place among group members via dual communications channels.

### CLAIM TO PRIORITY

This application is a non-provisional of U.S. Provisional Application 61/483,176, filed May 6, 2011, and entitled System and Method for Social Interaction, Sharing and Collaboration, which is hereby incorporated by reference in its entirety.

### FIELD

This disclosure relates to online social networking, and more specifically to real-time online social sharing and collaboration.

### BACKGROUND

There are currently many web-based social networking applications and websites, however none offer real-time, non-intrusive social interaction and collaboration features that enables private sharing and collaboration of a plurality of different content from a plurality of different content sources across a plurality of mobile devices that is immediate and seamless. Therefore there exists a need for improved online social interaction facilities.

### SUMMARY

One embodiment is a method for providing a real-time interaction. The steps of the method include opening a graphical user interface for forming a group for real-time communicating, accessing a remote server for communicating, forming the group in real time by manipulating a touch screen and maintaining dual communications channels between the remote server and members of the group.

Another embodiment is a method for providing a real-time interaction. The steps of the method include opening a graphical user interface on a mobile device for communicating with a group, accessing a remote server for sharing content among members of the group, addressing the group by manipulating a touch screen of the mobile device, wherein members of the group communicate via at least one channel of a dual channel communications network, and adding at least one person to the group in real time by manipulating the touch screen.

Another embodiment is a method for providing a real-time interaction. The steps of the method include opening a graphical user interface on a computer for communicating with a group, accessing a remote server for sharing content with the group, communicating with the group in real time via at least one channel of a dual channel communications system, adding at least one person to the group by manipulating a touch screen, and sharing at least one item with the group in real time by manipulating the touch screen.

These and other systems and methods, as well as advantages of the present disclosure will be apparent to those skilled in the art from the following detailed description of the embodiments, and from the drawings.

### BRIEF DESCRIPTION OF THE FIGURES

The disclosure and the following detailed description of certain embodiments thereof may be understood by reference to the following figures:

FIG. 1 depicts a block diagram of an embodiment of the method and system.

FIG. 1a depicts process flow for a typical interaction as shown on a representative mobile communications device.

FIG. 1b depicts a login screen on a representative mobile communications device.

FIG. 1c depicts a registration screen on a representative mobile communications device.

FIG. 2 depicts a main screen on a representative mobile communications device, which shows available individuals.

FIG. 2A depicts a main screen on a representative mobile communications device, which shows an individual added.

FIG. 2B depicts a main screen on a representative mobile communications device, which shows a prompt for naming a new collaboration session.

FIG. 2C depicts a main screen on a representative mobile communications device, which shows an individual invited.

FIG. 3 depicts an invite friends/associates screen on a representative mobile communications device.

FIG. 4 depicts items on a tray screen on a representative mobile communications device, which shows potential sources of content to share.

FIG. 4A depicts items on a tray screen on a representative mobile communications device, which shows a Facebook source selected.

FIG. 4B depicts items on a tray screen on a representative mobile communications device, which shows content from a Facebook folder selected.

FIG. 5 depicts items on a tray screen on a representative mobile communications device, where types of local-to-mobile-device sources are shown.

FIG. 5A depicts items on a tray screen on a representative mobile communications device, which shows a particular type of source selected, such as notes.

FIG. 6 depicts items on a tray screen on a representative mobile communications device, which shows an interaction history selection.

FIG. 6A depicts items on a tray screen on a representative mobile communications device, which shows a history from a particular interaction selected.

FIG. 7 depicts a live stage screen on a representative mobile communications device, showing a live interaction.

FIG. 8 depicts an item view screen on a representative mobile communications device, showing a shared item with command options.

FIG. 8A depicts an items view screen on a representative mobile communications device, showing information associated with a shared item.

FIG. 9 depicts a user profile screen on a representative mobile communications device.

FIG. 9A depicts a user profile editor screen on a representative mobile communications device.

FIG. 10 depicts an interaction timeline screen on a representative mobile communications device.

FIG. 10A depicts a friend/associate profile screen on a representative mobile communications device.

FIG. 11 depicts an embodiment of a dual communication channel for real time communications among members of a group.

While the disclosure has been described in connection with certain preferred embodiments, other embodiments would be understood by one of ordinary skill in the art and are encompassed herein. All documents referenced herein are hereby incorporated by reference.

### DETAILED DESCRIPTION

The present disclosure provides systems and methods useful for on-line collaboration and communication among two or more persons. While this on-line communication is possible using stationary computers and persons, there are additional advantages for persons on the move. Thus, advantages of the present disclosure are even more useful to owners and users of mobile devices. Mobile devices may include smart phones, as well as mobile internet-connectable computers, such as tablet computing devices.

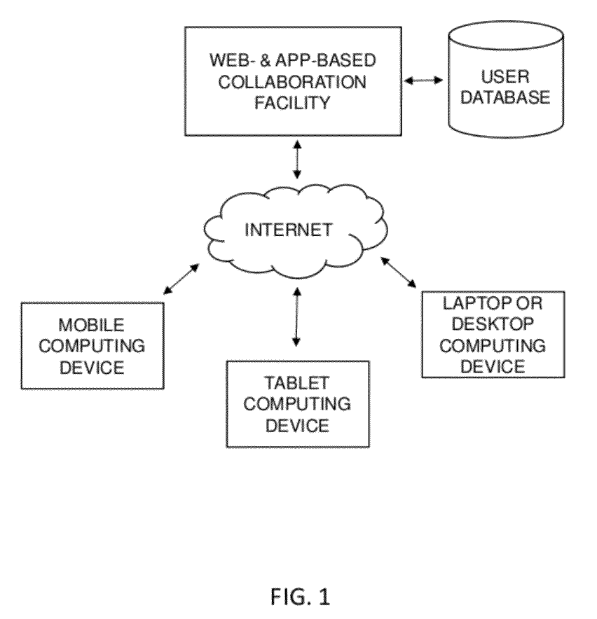

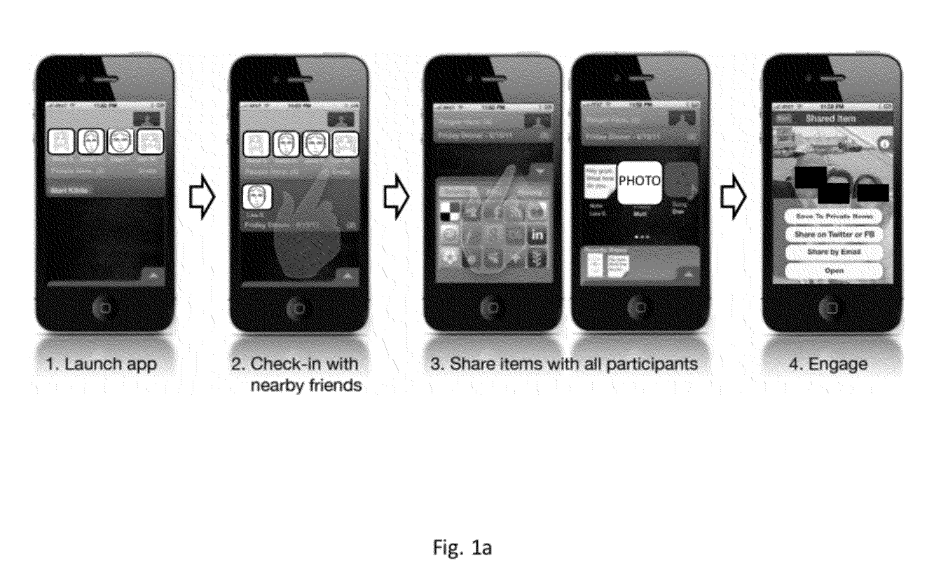

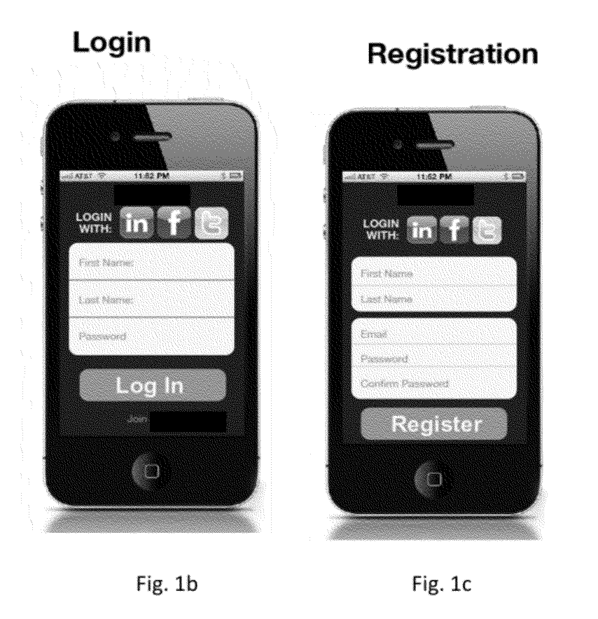

Referring to FIG. 1, methods and systems may provide for a real-time, discrete information-object focused, social interaction and collaboration service. The service allows for instant group creation (consisting of two or more persons), sharing, interactions, and the like, with minimal configuration requirements. The service may be implemented on a personal computing device, such as a mobile device (e.g. through a mobile device application), preferably with a global positioning system, a personal computer (e.g. through an application, through a cloud computing environment), a tablet computing device, and the like, and where one user interacts with a plurality of other users across the Internet to a web-based collaboration facility, such as implemented in a cloud-computing environment.

In embodiments, user data may be stored in a user database, such as in association with the web-based collaboration facility, e.g., a remote server for the application. The user database may be local, e.g., stored on the mobile device itself, or may be remote and available to the user in real-time, such as iCloud® or Dropbox®. Devices which already include communications ability and a position-locating ability are very useful devices for use with the present disclosure. Such devices are able to communicate using the Internet and are able to detect and to transmit their location through a global positioning system resident on the device. When items are shared among members of the group, the items are first uploaded to a user's account at a server, such as a remote server. The items are stored, typically in chronological order as received. The items are then downloaded to members of a group with which the user is then engaged, from the server to the individual mobile devices or computers of the users.

A method or process flow diagram is depicted in FIG. 1A. As shown in FIG. 1A, a user may launch the collaboration application on a computing device and create a group with friends who may be nearby or remote. The members of the group may then participate in the discussion. The user may then share items with other users as participants, and engage with the other participants, such as discussing the items or other topics of interest. In embodiments, the collaboration system may provide for a real-time, non-intrusive mobile process that is capable of a number of actions. These actions include selectively broadcasting the user's presence, creating interactions with private sharing and collaboration and sharing items. These items may include notes, universal resource locators (URLs), contacts, pictures, locations, videos, music, applications, events, documents, and other items. The application may also include the ability to recall key details of past meetings and interactions, as well as keeping track of the users and shared items for the present meeting. Examples of useful interactions or meeting among users may include social collaboration, real-time photo sharing, in-context recommendations and advice, on-the-fly planning and coordination and professional collaborations. These collaborations may include seamless capture and recall of meeting participants and discussions, instant document sharing, ‘zero-effort’ introductions, and similar smooth virtually spontaneous gatherings and sharing actions.

In some embodiments, participation among users may take place across multiple mobile communication devices not physically connected to each other. In some embodiments, all communications occur between the devices via a cloud-computing environment using the Internet. Through a graphical user interface (GUI) on a computer or a computer-driven mobile device, a user may see other users, nearby or remote. The presence of others may become apparent through a pop-up on the user interface, or through other indication on the user interface. The indication may be a thumbnail photo, an icon, an avatar, a name, a user id, and the like, of others registered or affiliated with the collaboration computer program. A user begins by logging in on a computer or other computer-based mobile device, as shown in FIG. 1B. The user may then register with the collaboration application and download the application, as shown in FIG. 1C. In one embodiment, the application is Kibits^{SM} and is available as a commercial application from vendors such as the App Store™. The user then creates groups for participation, such as an on-the-fly group in real time, or joins in with an established group.

A user operates the application in combination with a touch-screen that is available with smart phones or other highly interactive, mobile computing and communications devices. Such touch screens are typically not an option but rather are part-and-parcel of such devices. A user typically uses a variety of ways to begin collaboration with the group at hand. A user may drag-and-drop an item to share or an icon or other token of a person to invite collaboration. A user may invite another user to collaborate, such as by selecting the user from a list, such as their Address Book contacts, Facebook® friends, or Twitter® followers. A user may also invite another user to collaborate by making the presence of their group or person discoverable within a geographic area. Any users within this geographic can discover each other and send an invitation to a group for collaboration.

The invited user may automatically then receive an ‘invite,’ such as an invitation with a choice to accept or reject the invitation. For example, a first user, with a first device, who may be interested in local restaurants, may want to share an opinion, such as a recommendation, with friends. With a single tap or flick gesture, the user may be able to add a new individual into the collaboration area. When at least one user accepts, a group is formed. The group may be ad hoc, for that collaboration only, or the group, with a group name and at least two participants, may be saved in the memory of the user who began the group, as well as in the memories of the devices of each of the group members. The group may be re-called, i.e., a session initiated, by any one of the users selecting the group from the memory and beginning a sharing and collaboration session.

Once a group is formed and the users are in contact, any user or member that is participating in the discussion may share materials among the participants. For example, a user may select an item from memory, just as one selects a computer file for opening. The user then drags or flicks one or more files or “tokens” for the restaurant, such as a photo or a review of the restaurant, and the like, for sharing with other users in the collaboration group. The restaurant may be a nearby establishment, or may be representative of any other topic the group wishes to collaborate on or discuss.

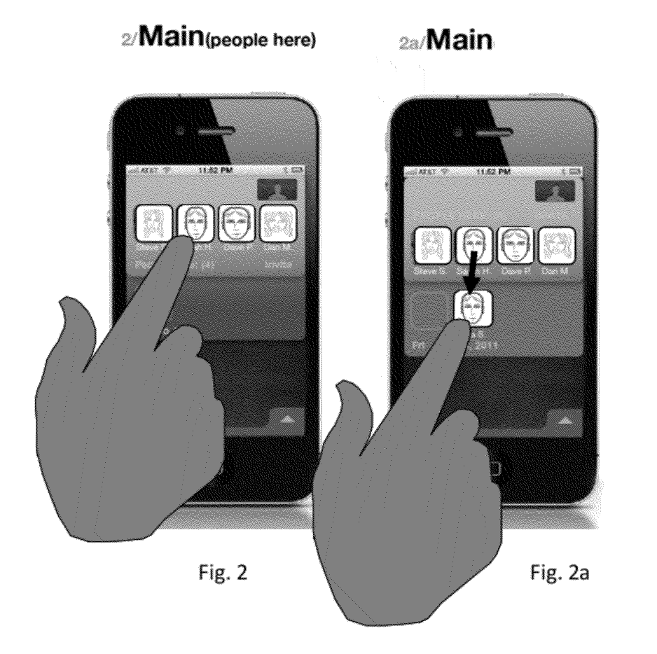

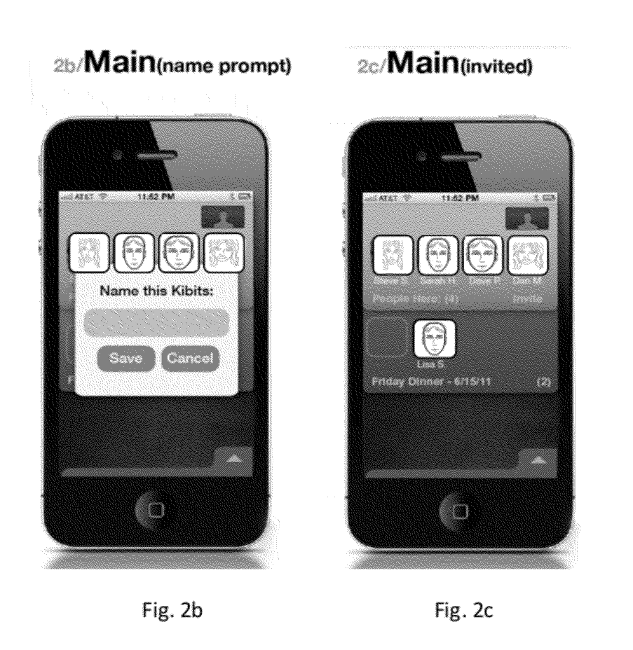

In FIG. 2, the user has logged in and has started the social interaction, sharing and collaboration application on a smartphone, such as an iPhone®. The figure discloses a menu with acquaintances and associates, i.e., contacts, of the user who may be invited to join a group. In FIG. 2A, the user has taped an icon of one of the contacts to invite them to a collaboration area. Thus, FIGS. 2-2A depict a user taping a contact, hopefully a new user, into the live staging area for collaboration. On a second device, a second user, the contact, will first see the invitation, and then the second user may ignore, decline or accept the invitation to join the group. The group may include these two users or may also include additional users.

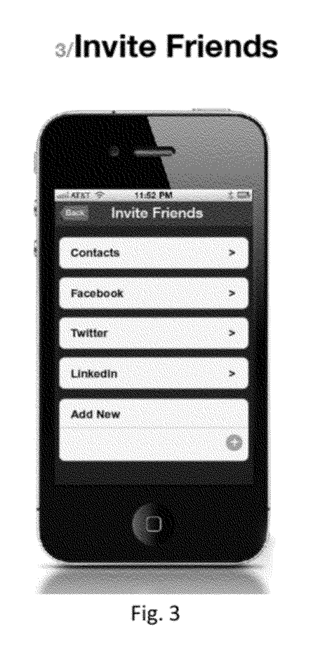

Additional details are presented in FIG. 2B and 2C. In FIG. 2B, the user has opened the application. Icons of the user's contacts appear on the screen, as well as a first screen inviting the user to begin the sharing session by naming the collaboration group or Kibits group, and also inviting the user to save the information. In FIG. 2C, the user has named the group or session “Friday Dinner,” and has invited one contact to join the group for the discussion. Friends or contacts, as shown in FIG. 3, may be gleaned from the user's other computer resources, such as friends in a computer file, a contact list, a list of instant message contacts, Facebook friends, Twitter contacts, LinkedIn contacts, and so forth. The user may also add new contacts by adding them to one or more of the lists or files. The files may reside on a computer, on the mobile device or on remote storage, such as a cloud storage site, a cloud computing site, or other memory. One site is a server for hosting the functions of this social interaction, sharing and collaboration system.

The person who is invited sees corresponding messages concerning the invitation on his or her smart phone or other computing device. If the invitee does not have the Kibits^{SM} application on his or her computer, the invitee is invited to download the application from the App Store™. Once the application is downloaded, the invitee can then see the invitation and is able to participate in real-time social interaction, sharing and collaboration sessions with other users. When an invitation to begin a session is received, the application is activated on the user's device. The invitation appears, along with indicia of the sender, and the name of the group. Other information may also appear, such as a menu in which the user is able to select “yes” or “no” on the touch screen of the device. Once the user accepts, the group is able to collaborate in real time, in a manner similar to instant messages. The first difference is that more than two users may participate in the session. The second difference is that no elaborate preparation for the meeting is necessary.

A third difference is that the participants may share objects or files, again in real time, without elaborate meeting set ups. A user who has accepted the invitation and joined the group sees those shared objects appearing on his or her device in real-time. If a user wishes to share a photo, the photo is sent to group participants and may be sent in more than one way. Selecting the photo, for instance, may send to each participant a low-resolution thumbnail, followed by a high-resolution full image. Similarly, the second user may send or flick content back to the first user. The second user may wish to share photos that are stored locally (e.g. restaurants the second user recommends), which then appear in real-time on the device of the first user. Further, one of the users may want to invite a third user. The third user first sees an invitation, accepts the invitation, and immediately sees who is collaborating, along with all the shared content, and similarly may share content with the group.

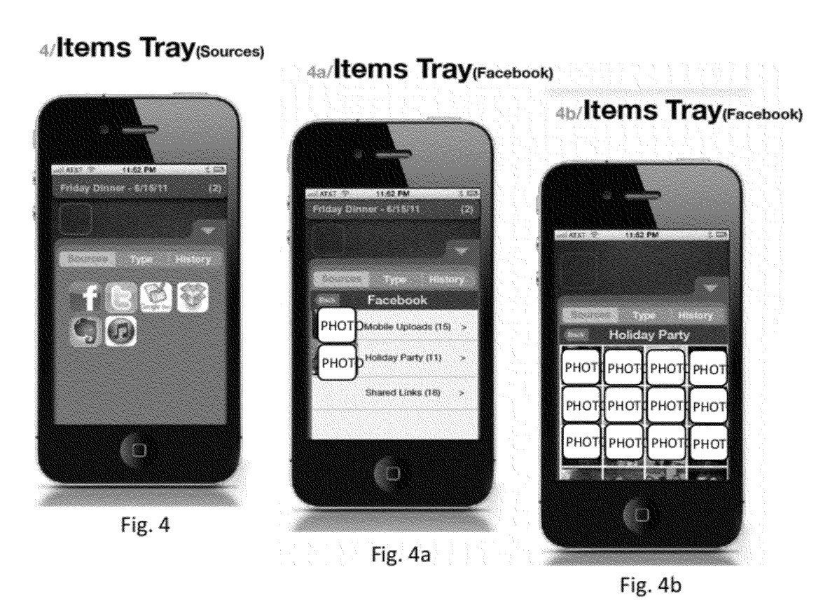

In addition, users may have the ability to share content from their sources, such as Facebook®, MySpace®, Twitter®, LinkedIn° , Dropbox®, iCloud®, and the like, as shown in FIG. 4. This allows users to share content from multiple sources of local storage. Users may share almost anything that can be stored as a computer file. This includes notes, links, photos, videos, contacts, songs, applications, events, and the like. For example, FIG. 4A depicts a user opening a submenu from a social networking site on which the user has stored photos, with two items shown, disclosing content from “mobile uploads” and from “holiday party.” In FIG. 4B, a plurality of photos from the “holiday party” submenu are disclosed, allowing the user to drag and drop or flick the photos onto the collaboration or sharing area between the holiday party menu and the upper portion of the device screen.

In one embodiment, a first user or initiator, A, creates a new group by naming the group, as described above, and then inviting several users, perhaps by inviting three friends, B, C and D, to join. The initiator may be local address book information, shared calendar events, or social network connections available to A. When the invitations are sent, B, C and D see the invitations immediately on their mobile devices or computers. The users see the invitations and tap on them to accept. The remote server observes the acceptances, which are immediately passed to the inviter, A. User B may share a photo with the group, as noted above for FIG. 4A. Users A, C and D receive notification that new content, a photo, has been shared into the group and that each can view it instantly. User D may comment on the photo and users A, B and C receive notification in real time of the comment and they can read the comment instantly.

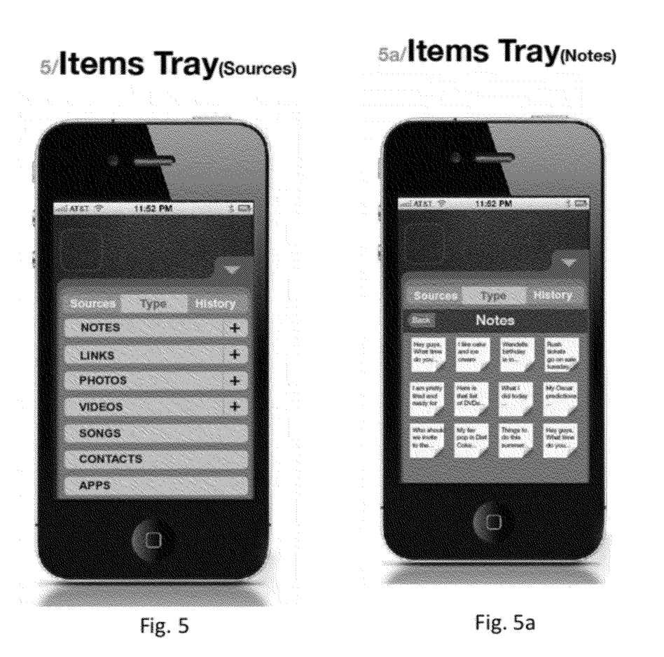

While dragging-and-dropping and flicking are convenient ways to move files or content to the collaboration area, some embodiments simply select a file for sharing. Thus, in FIG. 5, a mobile phone memory include a list of folders, such as folders for notes, links, such as URLs, photos, videos, songs, contacts and apps (application files). The “notes” file is depicted in FIG. 5A as having been selected, as with a finger or stylus of a user, with twelve files displayed for selection. The user then selects the files for sharing by tapping with the stylus. In some embodiments, an on-screen cursor may be available, and the user shares files by clicking or double clicking on the desired file. The application interprets the clicking as indicating sharing, just as flicking or dragging-and-dropping indicate sharing.

Another interesting way to form a group, or to join a group, is via a shared URL. The group is formed of members that have a common URL. The URL, an access site, is distributed to parties that are invited to join the group. The URL could be shared by members with other interested parties. The result could be a medium to large group, e.g., a group of conference attendees, a rally, or other large gathering. This would be useful because the URL could be used to form a group much larger than would be possible by manually flicking contacts or other icons into a collaboration screen on a smart phone or other mobile device.

In one embodiment, a first user or initiator creates a new group and opens the group to anyone with access to a private URL. In one embodiment, the system generates a custom or private URL that is uniquely associated with the initiator's group. The initiator then shares the URL with users who are invited to join the “URL group.” The invitation may be sent via e-mail, SMS, other social network or other sharing mechanism. The users receive the message and the URL and select it. Upon selection, each sees a pop-up alert that warns them they are about to join an open URL group and that others may join as well. In one embodiment, the initiator sees the other members join the group in real-time on the initiator's mobile communication device or computer.

Another interesting way to form a group, or to join a group, is via physical proximity of other users with whom the user is interested in collaborating. The group is formed of members that are within a pre-defined geographic region of one another. Each person that wishes to join the group navigates to a particular screen that makes their device discoverable to other devices in the region. As each member navigates to the screen, they show up in a list of all users that currently have also made themselves discoverable to the same geographic region. The imitator or creator can then name a group and invite the nearby users to the group. This would be useful because not all groups and collaborations take place between users who know or want to share each other's contact information, such as email address, phone number, or want to become affiliated on various social networks, such as Facebook or Twitter.

Another interesting way to form a group, or to join a group, is via physical proximity of a group that is made open to other users within a geographic region. The initiator or creator names the group and specifies a geographic radius around a specific geographic point that defines a region in which that group is available to join. Other users within that region, based on their device location services and GPS readings, are allowed to join the group. When a user enters the region and launches the application, an invitation to this group will automatically appear. This would be useful because some groups may be created for users who do not know each other, nor have each other's contact information to send an invitation, yet share a common interest about a subject taking place, such as a concert or industry summit, in a specific geographic area.

Once the group has begun, interactions take place on the basis described above. A group member may wish to share a file, such as a photo, with the group. When the photo is shared, it is shared with all group members. The other group members receive notification that new content is available and that the users can see the photo immediately. A user can view the photo and add a comment to the photo and share the comment with the group. The other members see a notification of the new content-comment in real time and can read the comment instantly. The initiator, or any of the members, can invite another user to join the group at any time after the group or the session has begun.

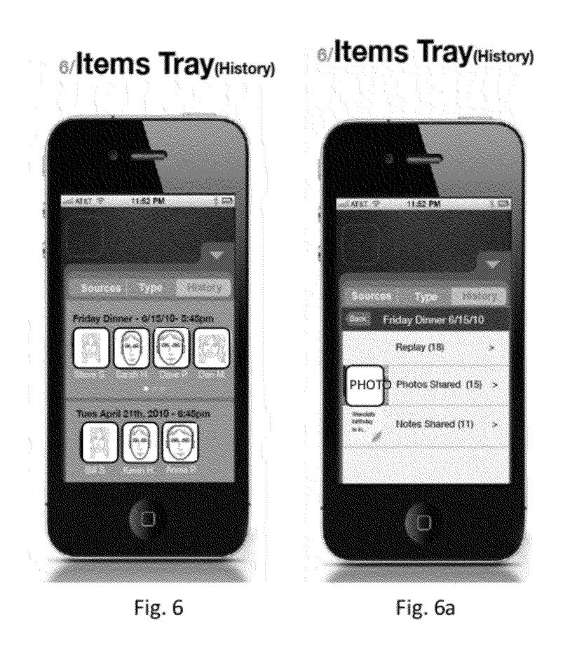

The application is able to save records of interactions, such as meetings of a group. In one embodiment, as shown in FIG. 6, a mobile device has stored a log or memory of at least two meeting of the user group “Friday Dinner.” The upper portion of the screen depicts a record of a meeting on Jun. 15, 2010 at 5:45 pm. The record depicts icons or representatives of four meeting participants and precisely which participants. In the bottom portion of the screen, the record indicates a previous meeting on Tuesday, April 11 at 6:45 pm, and the record indicates which three members attended.

The sharing application is also able to record and store particulars of meetings, as shown in FIG. 6A. In this depiction, a record of the interactions of the Jun. 15, 2010 meeting of the group is seen. The record depicts the photos and notes shared, and the record may also store the conversations and exchanges among the participants. In one embodiment, the exchangers among participants are stored in chronological order, i.e., the latest items are on the top of the list. In another embodiment, items may be stored in a different order, such as an order in which the most topical or most important items are stored on the top of the list. For example, if users share a first photo or other digital file, it may be followed by second photo or item, which would then be stored closer to the top. However, if the group discussion turned to the first photo, the first photo's position would be moved up; its importance seems greater because it was more recently discussed. The verbal or textual exchanges among the group may also be stored, in chronological order, or in another order, such as the order of importance. The order of storing, in one sense, is still chronological. The updated verbal exchange of the photo or other file reinforce the importance of the photo and ranks it more highly because it is more recent; i.e., more recent than its first introduction into the group and the history of the group session.

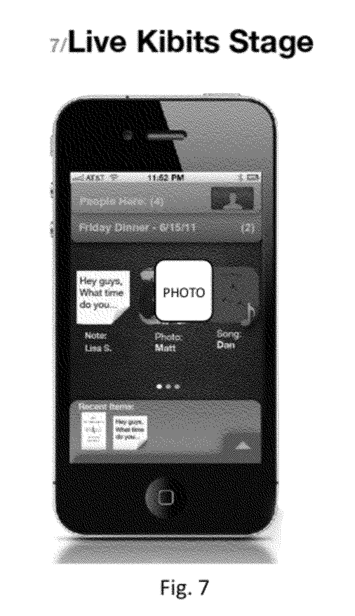

The interactions among participants takes place via text, as seen in FIG. 7, as well as with items shared among users. In FIG. 7, an active collaboration is in session. The interactions are taking place in the center of the screen, with the most recent sharing being a message from Lisa S. Previously, Matt shared a photo and Dan shared a song. The small window near the bottom includes small icons or indicators of recent items, i.e., a running history of the session. The shared items, as well as all the verbal exchanges, may be saved on the user's device, at the option of the user of each device.

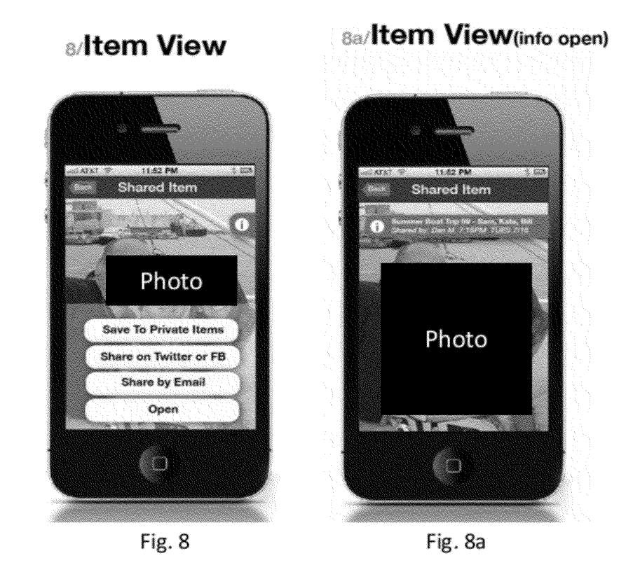

The present disclosure includes additional examples of storing and sharing content on devices used in practicing these methods. For example, a photo has been shared in a session attended by the user in FIG. 8. The user has touched the photo, with a finger or a stylus, and a menu has popped open asking the user what he or she would like to do with the item. In this example, the menu presents three options for storing the photo in the file named “private items,” or to one or more of the user's social media accounts, or to share via e-mail. A fourth option, “open” invites the user to open the presented file, which may be a thumbnail photo, so that the user can see the photo, as depicted in FIG. 8A.

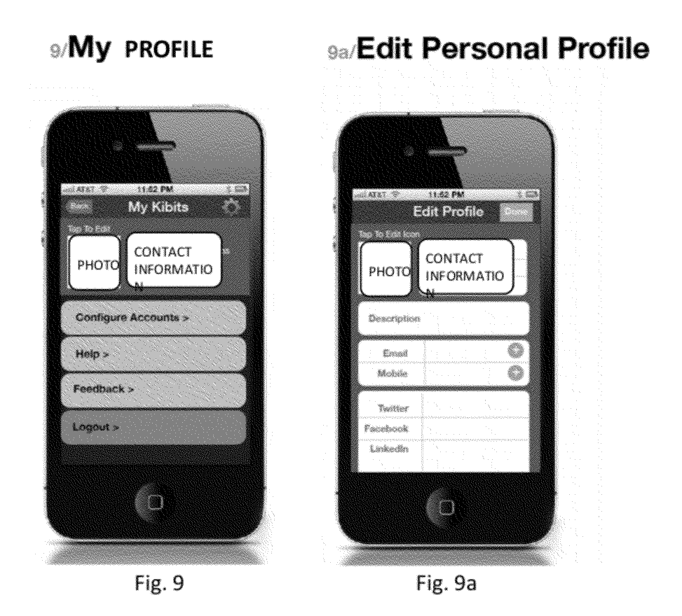

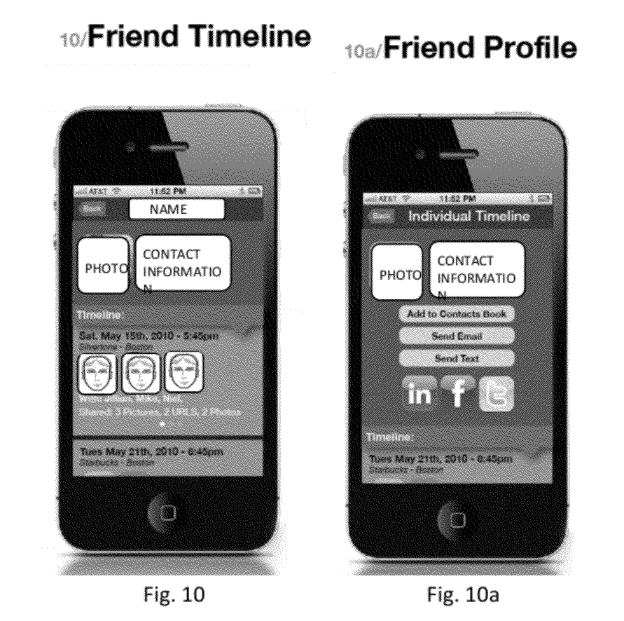

While the system and method for social interaction, sharing and collaboration described herein is very useful, members can derive additional utility and enjoyment from the application by first setting up the application according to their desires. A few details of some embodiments are depicted in FIGS. 9, 9A, 10 and 10A. In FIG. 9, the user is adding his own profile, e.g., a photo, perhaps for later sharing, and also his contact information, also for sharing. FIG. 9A depicts editing the user's profile with additional details that will make for easier sharing and collaboration, such as the user's social network addresses and related information. FIGS. 10 and 10A depict how the user can also download similar information from the user's friends and their contact information for this and other applications.

The interactions between users are intended to be in “real time” and as instant and reliable as possible, certainly much faster than other methods, such as e-mail. In one embodiment, communication takes place via an ‘indirect’ channel, e.g., a push notification network. A push notification network may be provided by a device maker, sometimes in combination with a telecommunications company through whose channels the communications take place. An example is Apple Inc.'s Apple Push Network (APN) used in Apple's APN service (APNs). Embodiments may include the Apple Push Network and Android Cloud to Device Messaging Framework (C2DM), as well as other systems. These systems only provide one-way messaging and do not guarantee the delivery or timeliness of messages. They do, in general, have the ability to send a message to a device, which relays the message to an application installed on the device when the application is in any state (i.e. active, foregrounded, backgrounded, or inactive). They also have the ability to store and send messages in the case receiving devices are offline at the time the message is sent.

In a particular sharing session, the application may go quiescent if there has been no activity on the device for more than a certain period of time or the user changes the application to a backgrounded or inactive state. Services like APNs do not adhere to quality of service provisions, particularly related to guaranteed delivery and timeliness of message delivery. This means that there may be delays in delivery or the message may not be delivered at all. Sometimes, therefore, APN messages arrive almost instantly but at other times they may be delayed by minutes of more. Given this channel's indirect nature, there is also no reliable way to acknowledge that a message has been received in order to guarantee delivery.

As a result, a second ‘direct’ channel may be used in the devices described herein, e.g., WebSocket technology. WebSocket is a web technology that provides for multiplexing bi-directional, full-duplex communications channels over a single TCP connection. One example of this technology is the format standardized by the Internet Engineering Task Force (IETF) as Request for Components (RFC) 6455. A WebSocket application permits a sharing and collaboration application to ‘listen’ actively on a specific channel for updates, in a manner similar to mesh network nodes listening for messages. Thus, in one embodiment, a WebSocket application is direct, active, and stateful, and supports two-way messaging with instant distribution and guaranteed delivery if the application is active and/or foregrounded. Delivery is guaranteed using a send, receive, and acknowledge protocol.

This ‘direct’ channel allows for consistent, near instantaneous delivery of updates and works via a direct, active connection to the application rather than an indirect relay via a third party system. However, this secondary channel may only be available when the application is active and foregrounded. Thus, both a ‘direct’ and ‘indirect’ channel may be used in parallel in efforts to ensure real-time content delivery. Examples of WebSocket technology may be found in a variety of Web browsers, including Firefox and Google Chrome. Internet Explorer supports at least some aspects of WebSocket applications.

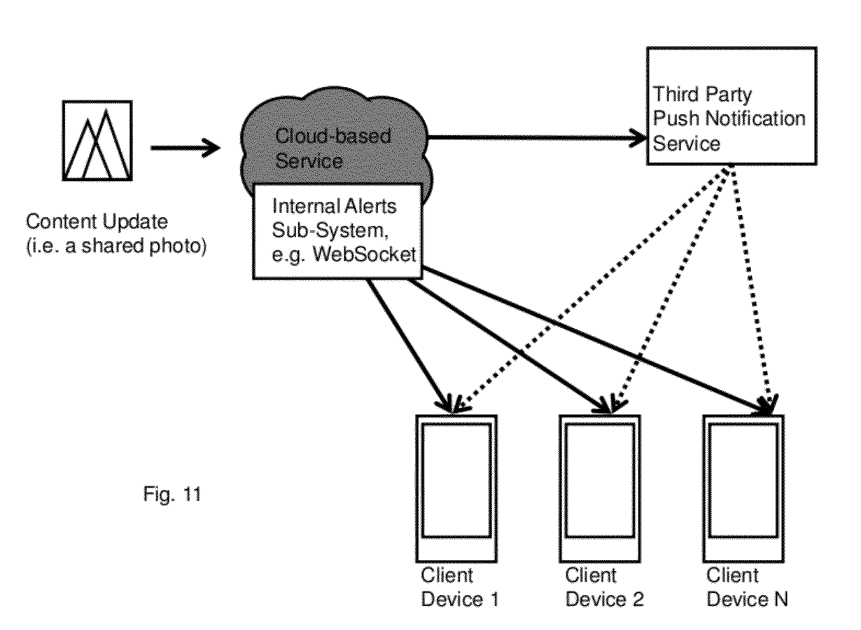

A depiction of a redundant delivery system and method is shown in FIG. 11 of the application. In this system, the mobile communication devices of a plurality of clients, client 1, client 2 to . . . to client N, are in direct communication with a server (solid arrows) through a WebSocket application channel. The server may be a cloud-based service, e.g., a remote server, for providing content to subscribers. As noted in FIG. 11, communication between the client and the server is direct, active and stateful, i.e., alert. Its properties include near-instant distribution, with foreground alerts and two-way messaging. The two-way messaging allows back-and-forth communication between the each client and the server. The distribution properties allow for near-instant forwarding of content from one member of a discussion group to another. This channel may not be available if the client application is inactive or backgrounded or the device is offline.

The second portion of the communication system is a third party push network or push notification service, e.g., APN. The third party push notification service channel is in communication with each of the client device, see dashed arrows, and with the application via a relay mechanism. This portion of the redundant network does not guarantee the delivery of messages and has slower service in most conditions, but is available even if the client application is inactive or backgrounded. The server of the push notification service may also be remote, e.g., a remote server, for storing and sharing content and messages.

Each client device is in communication with both channels simultaneously, i.e., each client device listens to both channels. When new alerts or message arrive, internal logic of the application on the client device determines which alerts are valid, e.g., “new,” and should be displayed on the client device. Internal logic also determines which alerts are invalid, e.g., duplicative, and should be ignored.

An advantage of some embodiments of the disclosed system and method is to selectively broadcast an inquiry that is transmitted only a short distance, e.g., 1000 ft (about 900 meters). The system may also be used for users within a shorter distance, e.g., within the same room or within the same building. This method may be used to identify user who want to create or join a group with someone not already connected via existing signals from another shared address book, e.g., connected via a social network, a to display their contact information (and hence be available to be invited to join a group) to each other for just a few seconds. This is useful for users who want to create or join a group with someone nearby that isn't already ‘connected’ via existing signals such as a shared address book entry, being Facebook friends, having a calendar appointment, etc. This also allows users to leverage personal location information on a selective basis—without constantly/indiscriminately broadcasting where they are.

The mobile broadcasting technique works in a very simple manner. User A, the initiator, navigates to a desired screen in the application and enables location services and permissions. In one embodiment, the initiator knows his or her physical location through the Global Positioning System on the smart phone. The initiator creates a new group with a desired name. User A then makes the group visible to any other site user of the social interaction, sharing and collaboration system, so long as the users are within the given distance, for a given period of time. In one embodiment, the user may select an hour, or perhaps less time, as desired. In this example, three users, B, C and D are nearby, within the selected distance. They have also enabled location services with the system. When these users open the application on their devices, each sees that user A′s group is available to join.

B, C and D accept the invitation to join by tapping the invitation. When they tap, each sees a pop-up alert that warns them they are about to join an open group and that other people can join in. For example, User E, 500 miles away, does not see the invitation. User A, the initiator, sees users B, C and D join in real time. User B may share a photo with the group. Users A, C and D each receive notification that a photo has been shared into the group and that each can view it instantly. User D may comment on the photo and users A, B and C receive notification in real time of the comment and they can read the comment instantly. In this example, user A, or any other user, may manually invite user E, far away, to join the group.

This technique requires synchronized behavior from two or more people in order to share the relative proximity of the parties. This technique facilitates adding people nearby to a group. Once the user navigates away from the particular screen of the application, or closes or backgrounds the application, the user location data is no longer shared and the person once again become “invisible.” Note that this functionality is made possible by the real-time update techniques described above. In general, the mobile communications device leverages device location and relative proximity data in interesting and unique ways to facilitate the rapid creation of real-world groups. That is, in one embodiment, a group formed by this technique automatically includes people who are in the same place at the same time. An example would be people attending a business conference, or a social meeting, such as a party or a wedding. This application system creates a group that is accessible only to those people who have the same application and are in that location at that time.

Other techniques may also be used to locate nearby parties. For example, User A may already have created a group and may now wish to invite other nearby people who are not members of the group, e.g., people attending the same meeting or even in the same meeting room. Each of A, B, C and D open the application and navigate to the Invite people>Nearby tab. While this screen is being displayed, each user shares his or her relative proximity information with other users who are both one the same screen at the same time, and within a given distance, perhaps 500 feet or 1000 ft (about 450 or 900 meters). Each of A, B, C and D are nearby, all in the same room, and can see each other, i.e., each other's profiles, in the Nearby tab. User A selects the displayed profiles for users B, C and D and selects the Invite button.

Users B, C and D receive invitations instantly on their mobile devices or computers and each taps to accept the invitation. Each is instantly added to the group. User A sees the acceptances in real time. The same group dynamics taught above now apply for sharing and collaboration among members of the group.

There are many ways to form a group, using desired combinations and steps of the above disclosure. For example, an originator, User A, may form a group by any of the techniques discussed above. User A may create the group and then invite User B via a shared calendar entry, e.g., a meeting between A and B in the near future. User A may then invite user C via C's e-mail address, and may then open the group to nearby users, e.g., Kibits users. Later, User A opens the group to those with a particular private URL, and A shares that URL on a social network. In this scenario, Users B, C, D, E, F, G and H each see the invitation or receive the invitation in real time, based on their individual device and on the mechanism used for the particular invitation. Each of B, C, D, E, F, G and H accept the invitation by tapping on the invitation on the touch screen. User A then sees each join the group in real time, using the two communications channels, only one of which actually operates at a given moment to send communications from the remote server to members of the group. In this example, User B takes a new photo and shares it into the group by techniques described above. A, C, D, E, F, G and H receive notification that a photo has been shared into the group and is available for instant viewing.

While the disclosure has been described in connection with certain preferred embodiments, other embodiments would be understood by one of ordinary skill in the art and are encompassed herein.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, 4G, LTE, WiMAX, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

All documents reference herein are hereby incorporated by reference.

What is claimed is:

1. A method for providing a real-time interaction, comprising:
opening a graphical user interface for forming a group for real-time communicating;
accessing a remote server for communicating;
forming the group in real time by manipulating a touch screen; and
maintaining dual communications channels between the remote server and members of the group.

2. The method of claim 1, wherein the dual communications channels comprise a direct communication channel and an indirect push communication channel.

3. The method of claim 1, further comprising inviting at least one person to the group by moving an indicator of the at least one person into a collaboration area on the graphical user interface.

4. The method of claim 3, wherein the indicator is selected from the group consisting of a URL, a photo, an address, an e-mail address, an avatar and an icon.

5. The method of claim 1, further comprising sharing an item with the group in real time by selecting an item or by moving the item into a collaboration area on the graphical user interface.

6. The method of claim 1, wherein the at least one person is added to the group by a gesture of flicking an indicator of the at least one person into a collaboration area on the touch screen.

7. The method of claim 1, wherein an indicator of the at least one person is available on a menu selected from the group consisting of a contacts listing, a social-media site, a business-related social networking site, a list of e-mail addresses, a list of instant message addresses, a cloud storage and computing site, and a web-based file hosting site.

8. A method for providing a real-time interaction, comprising:
opening a graphical user interface on a mobile device for communicating with a group;
accessing a remote server for sharing content among members of the group;
addressing the group by manipulating a touch screen of the mobile device, wherein members of the group communicate via at least one channel of a dual channel communications network; and
adding at least one person to the group in real time by manipulating the touch screen.

9. The method of claim 8, wherein members of the group communicate via a direct communications channel and communicate alternatively via an indirect channel.

10. The method of claim 8, wherein the group communicates via a WebSocket channel.

11. The method of claim 8, wherein the group communicates via a push network.

12. The method of claim 8, further comprising saving a record of group communications.

13. The method of claim 8, further comprising inviting the at least one person to join the group by moving an indicator of the at least one person into a collaboration area on the graphical user interface.

14. The method of claim 8, further comprising inviting the at least one person to join the group, wherein an indicator of the at least one person is available on a list selected from the group consisting of: nearby users, a contacts listing, a social-media site, a business-related social networking site, a list of e-mail addresses, a list of instant message addresses, a cloud storage and computing site, and a web-based file hosting site.

15. The method of claim 8, further comprising sharing an item with the group in real time by moving the item into a collaboration area on the graphical user interface.

16. A method for providing a real-time interaction, comprising:
opening a graphical user interface on a computer for communicating with a group;
accessing a remote server for sharing content with the group;
communicating with the group in real time via at least one channel of a dual channel communications system;
adding at least one person to the group by manipulating a touch screen; and
sharing at least one item with the group in real time by manipulating the touch screen.

17. The method of claim 16, wherein the dual channel communications system includes a WebSocket communications channel.

18. The method of claim 16, wherein the dual channel communications system includes a push network.

19. The method of claim 16, wherein the step of opening the graphical user interface is accomplished by opening an application on the computer.

20. The method of claim 16, further comprising forming a group by sharing a URL among members of the group.

21. The method of claim 16, further comprising storing communications and items shared among the group chronologically or by order of importance.
